(19) United States
(12) Patent Application Publication
(10) Pub. No.: US 2007/0116238 A1
(43) Pub. Date: May 24, 2007

(54) METHOD AND SYSTEM FOR ON-LINE TRADING

(76) Inventors: Yaniv Jacobi, Kirvat Ono (IL); Philippe Lang, White Plains, NY (US); Gabriella Berger, Ramat Gan (IL)

Correspondence Address: GOTTLIEB RACKMAN & REISMAN PC, 270 MADISON AVENUE, 8TH FLOOR, NEW YORK, NY, 100160601, US

(21) Appl. No.: 11/465,243

(22) Filed: Aug. 17, 2006

Related U.S. Application Data
(63) Continuation-in-part of application No. 11/248,379, filed on Oct. 11, 2005.

(51) Int. Cl. H04M 3/00

(52) U.S. Cl. 379/265.01

(57) ABSTRACT

A website run by a server can be accessed by many visitors. Service and support for the website are provided by a live agent at a call center by engaging the visitors in verbal conversations. A conversation is initiated when a visitor requests telephone assistance on the website. Information about the visitor, including pages he has visited in a current or previous visit is placed in a data file or record. In response, the live agent obtains the record corresponding to the visitor and a telephone link is automatically established between the agent and the visitor.

### RELATED APPLICATIONS

This application is a continuation-in-part of application Ser. No. 11/248,379 filed Oct. 11, 2005 and incorporated herein by reference.

### BACKGROUND OF THE INVENTION

1. Field of Invention

This invention pertains to a method and system for providing automated telephone communications between a website visitor, a server associated with providing goods and services to visitors and one or more live agents associated with, but preferably remote from the server. The invention is particularly useful for websites related to e-commerce.

2. Description of the Prior Art

Originally, the Internet was used by many people as a source of free information or as a source of entertainment. However, various advances in the field led to the establishments of virtual stores run by e-commerce merchants for selling various goods and services. These virtual or ‘on line’ stores are used by potential customers in the same way as in the ‘real’ or so-called ‘brick-and-mortar’ stores. That is, people often visit and browse through both types of stores to see what is available, and shop around for prices.

In both kinds of stores, human interaction becomes crucial to convince a visitor who is “just browsing” to become a customer. In the real store, this task is performed by a skilled salesman. In ‘virtual’ stores, a similar function is available as well, usually in the form of a live chat during which the visitor and the agent exchange text messages. During these chats the visitor receives information and answers to questions related to the products and services being offered. While a chat is going on the agent may have access to various information about the visitor, including the pages on the site that the visitor has seen, the contents of his shopping cart, if any, and in some instances, even details of previous visits to the website. As a result, the agent is much more versed in what the visitor's interests are even before engaging in the chat session. Thus, the exchange between the visitor and the agent is much more effective and informative for both parties. A system that allows a visitor to see a web site and interface with an agent in this manner is available from LivePerson, Inc., New York, N.Y.

In some instances, visitors prefer to talk to an agent rather then communicating via a chat session. However, if the visitor calls up an agent, the agent does not have the same information about the visitor as during a chat session, and, accordingly, servicing a visitor through a telephone call is much less informative and satisfactory for both parties.

### SUMMARY OF THE INVENTION

A system is presented that may be used to implement e-commerce or provide other information and services to various visitors. The system includes a server connected to the Internet and providing access to a website associated with the server. The website is reviewed by many visitors, the activities of the visitors are monitored and a record is stored so that it becomes available each time a visitor returns to the website.

The system includes a call center with one or more workstations used by a live agent for the purpose of assisting visitors. Visitors can communicate with the live agent either by an (optional) on-line chatting feature or by establishing a telephone communication channel. For establishing a telephone call, a visitor is presented with a link (embedded in image or text) on one or more pages of the website. A visitor can then request a telephone call by activating the link. The information for each visitor is presented to a live agent. Optionally, current waiting times for accessing live agents may be displayed on the website so that they can be seen even by visitors who have not yet requested a call or who have no interest in a live telephone call with and agent.

There are a few ways of connecting visitors to agents: one is “visitor first” and another is “operator first”. Visitor first—as soon as a website visitor requests a call, the server calls this visitor's phone and when the visitor answers the server initiated a second call to the call center and connects both calls. The advantage of this method is that visitors get an immediate call as a result of their request. Operator first—when the visitor requests a call, the server calls the call center first and only when the agent answers, the server initiates a second call to the visitor and connects the calls. In this case the advantage is that the visitor is being called only when an agent is available to treat his call, and until that time the visitor receives web notifications of the queue status and average wait time.

A third option of connecting website visitors to phone agents, is by using a headset (or microphone and speakers) and talking directly from the PC.

Once connected, the agent and the visitor can then engage in conversation preferably while viewing the same pages of the website. The agent can respond to verbal questions by the visitor, and can provide information by pushing web pages to the visitor and other similar means. The agent and the visitor can co-browse the website, co-navigate the website and can cooperate in filling out forms, such as an order form for a product or service.

After an encounter with a visitor is completed, the agent generates a record of the encounter including information about the visitor. The information is stored in a file kept for the visitor and/or used for marketing studies.

### BRIEF DESCRIPTION OF THE DRAWINGS

FIG. 1 shows a block diagram of a system constructed in accordance with this invention;

FIG. 2 shows a flow chart for the system describing the initial processing of a visitor to a subject website;

FIG. 3 shows a flow chart for the system indicating how the actions of the visitor are monitored by the system and how the system handles requests for telephone assistance;

FIG. 4 shows a flow chart for the queuing telephone assistance requests; and

FIG. 5 shows a flow chart for the system indicating the interaction between the agent and the visitor during a telephone conversation.

### DETAILED DESCRIPTION OF THE INVENTION

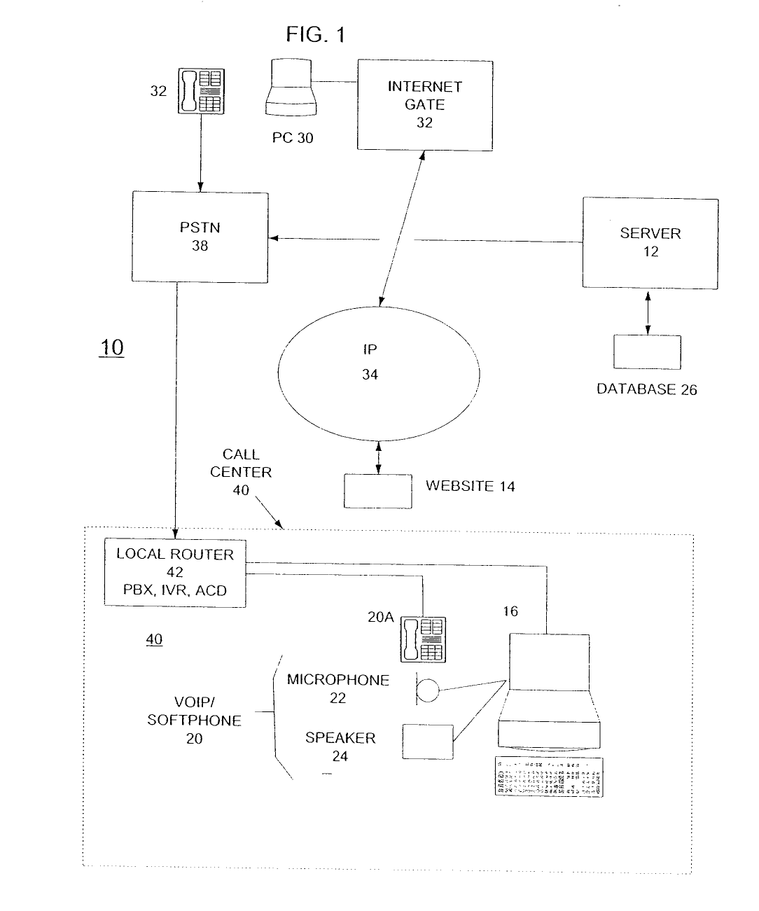

Referring now to FIG. 1, a system 10 is illustrated that includes one or more servers 12 communicating with a website 14 and running various backend applications. A server 12 may be run, for example, by an e-commerce merchant selling goods or services. Alternatively server 12 may service several merchants.

The system further includes a call center 40 that is used to provide some personalized service for visitors of the website 14 using one or more live agents. Each live agent has a live agent station 16. There could be many different stations 16, however only such station is shown for the sake of simplicity. The call center 40 is located at a remote site from the server 12 and the two can communicate by Internet or other means as discussed in more detail below.

The station 16 may be implemented as a workstation that includes a PC or other similar equipment that allows the live agent to monitor what is happening on the website 14, and to interact with visitors as described in more detail below. These functions are performed using a client program resident on the PC and serviced by server 12 as discussed in more detail below. Preferably, the agent can talk with website visitors (as well as other parties) through an Internet telephone 20 using VOIP. The telephone 20 includes a microphone 22 and a speaker 24, both coupled to the workstation 16. Alternatively, the live agent can also talk to a visitor over a standard telephone 20A.

The call center 40 is connected to a standard telephone system (PSTN) 38 through an internal router 42 that is used to connect an incoming call to any one of several work stations 16 in accordance with a predetermined protocol. The router 42 may be a standard PBX or may be a programmable switch adapted to connect calls to work stations using an internal call distribution system, an interactive voice response system, etc.

A visitor having an Internet access device 30 such as a PC, or other similar means, can access the website 14 by establishing a connection to his Internet gate 32, which then couples the visitor to website 14 via the Internet 34 in the normal manner. Of course, it should be understood that a large number of visitors can access the website 14 through appropriate Internet connections at any time, and that a single visitor is shown herein for the sake of simplicity.

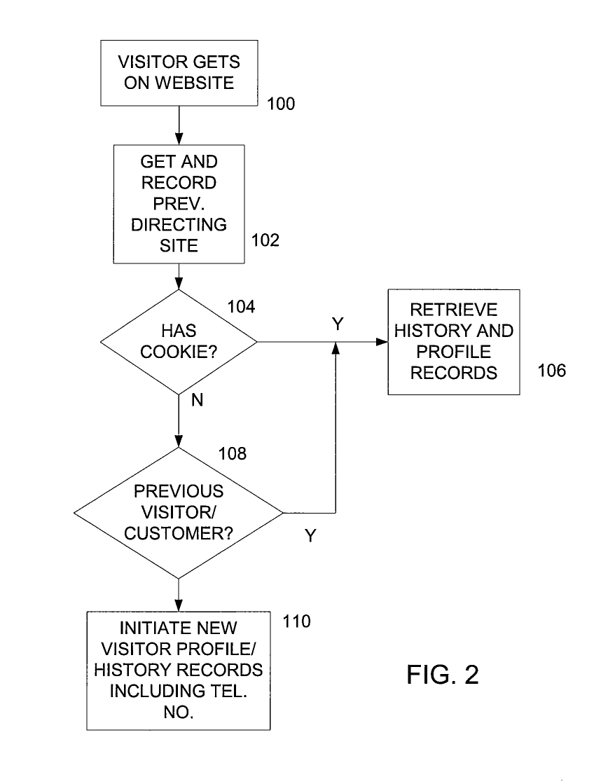

FIG. 2 shows how each visitor is handled by system 10. In step 100 a visitor gets on the website 14, either directly, e.g., by using the URL number of the website 14 or, indirectly, by being directed to the website from another site, such as a search engine, a website that includes e-commerce merchant listings, etc. In step 102 the tracks of the visitor are reviewed to identify and record the referring site (if any). This information is used for many purposes, including statistical studies to determine how visitors find the website 14. Moreover, the respective e-commerce merchant may have agreements with third parties which require the merchant to pay them for any referred visitors.

Next, the identity of the visitor is established. This can be accomplished in a number of different ways. For example, in step 104 a check is performed to determine if the visitor's PC 30 has any cookies indicating a prior visit. If a cookie is found, then it is retrieved and used in step 106, to retrieve the visitor's record. This record can consist of various information, including name, e-mail address, physical address, telephone number, credit card used, list of pages viewed in previous visits, list of goods and services bought, goods and services on his wish list, etc. If no cookie is found in step 106, then in step 108 the visitor is given the opportunity to identify himself as either a previously registered visitor or customer by entering his name and password. These items are then used in step 106 to retrieve the appropriate record for the visitor. If this is a first visit, then in step 110 the visitor is given the opportunity to become a registered visitor and provide the information required to generate a record. Of course, the visitor may decide not to be registered, in which case a record may be started and used at least for this visit. When the visitor signs off and/or leaves the website 14, his record may still be stored and kept until his next visit. The records of visitors are stored in databases 26. The information from step 102 regarding the referring site that directed the visitor to the present site 14 is made a part of the record for the visitor and/or added to other data bases. Information, such as what search words were used on another search engine to arrive at the present site may also be stored.

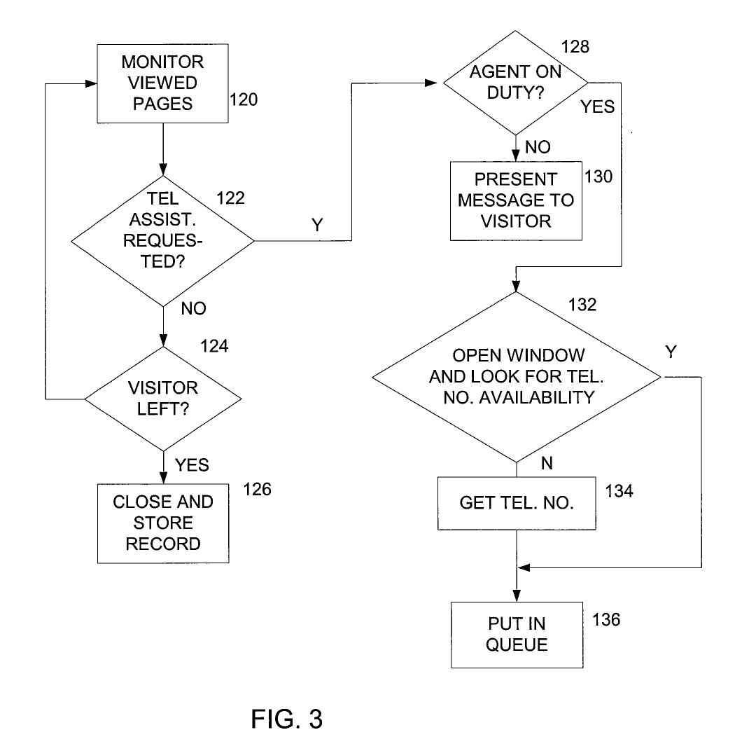

Once the visitor is on the website 14 (and hopefully, but not necessarily has signed in, or is otherwise recognized), he can then browse various pages of the site, with the server 12 monitoring these actions in real-time, as described in the flow chart of FIG. 3. More specifically, each page viewed by the visitor is added to the record of the visitor. The visitor can also order goods or services on line, send e-mail to various departments associated with the website and providing support, such as sales, marketing, customer service, returns, etc.

As mentioned above, some websites also give the visitor the opportunity to chat with an agent. One service providing this capability is the above-named LivePerson company. For this purpose, at least some of the pages provide the visitor with an opportunity to get further help through a direct, one-to-one telephone conversation with an agent. For example, some pages may contain a box with the legend “DO YOU WANT TO TALK TO A LIVE AGENT? CLICK HERE.” The server 12 checks if any visitor has requested a telephone assistance at regular intervals, as indicated at step 122. If no such request is received, in step 124 a check is performed to determine if the visitor has left. When he leaves, his record is closed and stored in memory 26 (step 126) until the next visit. Otherwise, the actions of the visitors are continued to be monitored, as shown in step 120.

Referring back to step 122, if a visitor does request telephone assistance, then in step 128 a check is performed to determine if there are any agents on duty at the call center 40. The live coverage provided by an e-commerce merchant may be discretionary. For example, a merchant may provide live agents a couple of hours on working days, while other merchants may provide live agents 24/7.

Of course, the call center 40 may provide live agents for several different merchants, and each merchant may select the times during which this service is made available. For these arrangements, the test in step 128 is to determine whether there is a live agent available for the merchant associated with the particular website being visited.

If there is no agent on duty, then in step 130, the visitor is presented with the options to leave a text message, a voice message with his telephone number, or retry later. In yet another embodiment, if no agent is available, then step 122 could be omitted, or the box associated with telephone assistance may be modified to show that no agents are on duty, even before the visitor clicks on the box.

If in step 128 it is determined that there is an agent on duty, then in step 132 a window is opened for managing the telephone event and a check is performed to determine if a telephone number is available for the visitor. For example, if the visitor is a customer or has registered previously, his telephone number may be part of his record. If no telephone number has been previously obtained, then in step 134 the visitor is asked for the number where he wants to be reached. Additional information may also be requested from the visitor and entered into the record automatically. This information may include a description of the product, service that he is interested in, a description of any problems that he may have encountered with the product, service, the website 14 itself, or other information. All this information is processed preferably through the window opened for this purpose in step 132. Then in step 136 the visitor is placed in a queue with other visitors. As long as the window remains open, the system assumes that the visitor is still interested, even if starts performing other tasks on his device, or visits other websites.

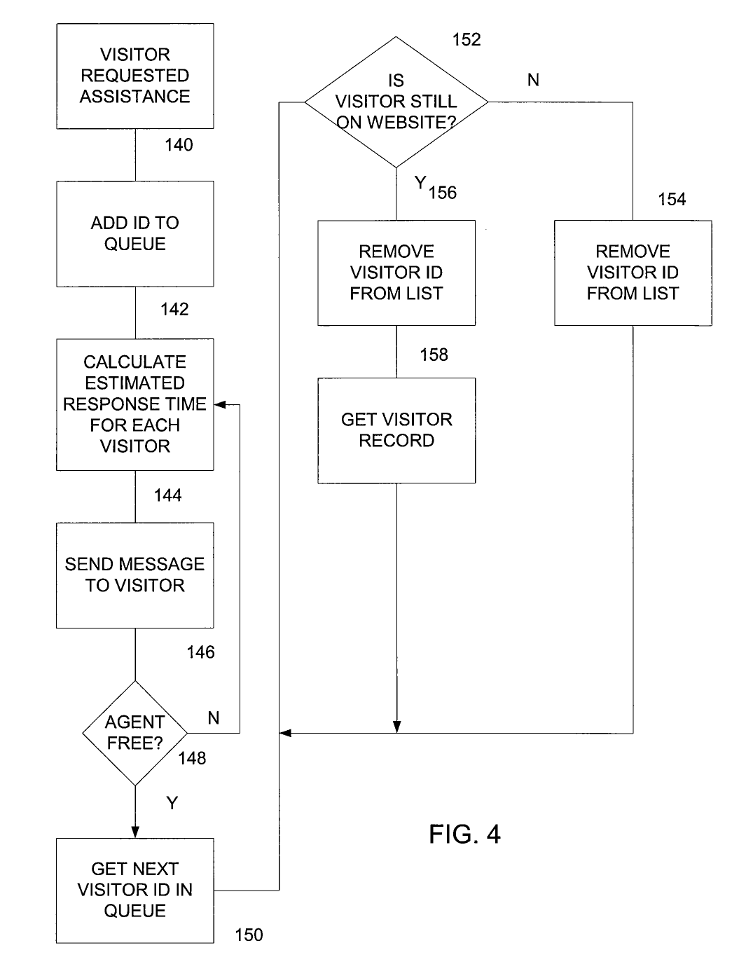

Details of how requests for live agents are handles are shown in FIG. 4. In step 140 a request is received from a new visitor. In step 142 an ID associated with the visitor, including his record is added to the queue. In step 144 an estimated time is determined by server 12 for responding to the requests from each visitor in the queue. This estimate may be made based on the number of visitors in the queue, the average time spent by an agent per visitor and the number of agents on duty at the control center 40. Of course other criteria may be used to determine an estimated response time as well. A message is then generated in step 146 on the visitor's PC 30 indicating some information about how long is the wait for the next free agent. The information may include the position of each visitor in the queue, the expected waiting time derived in step 144, etc. For example, the message may indicate that the visitor is 6^{th} on line, 3^{rd} on line, etc. The message can appear as a pop-up message. Keeping visitors informed about the their position in the queue and how long they still have to wait is important because it gives visitors a feeling that the system/merchant cares about its customers and is trying to accommodate them.

In the present invention requests for live agents are managed by the router 42 and the client software installed on the PC 16. In step 146 the call center 40 is alerted that a visitor has requested live service. The visitor's profile and other information previously collected, as discussed above, is used by the router 42 to determine which agent should be assigned to the visitor. If the agent is not available, then the time to respond is estimated and information is provided to the visitor regarding his request and the time it will take for him to get to an agent. Steps 140, 142 may be repeated on the fly for each new visitor.

While waiting for the next available agent, the visitor is free to browse through the website and hopefully is still available. However, while waiting, the visitor may have lost interest, or may have decided to go on to other tasks. In step 148 an agent becomes free and is presented with the next visitor on the queue. In step 152 a check is performed to determine if the visitor or visitors in the queue are still interested, and that the windows opened on their PCs are still open and active. If a visitor closes the managing window opened in step 132 then the system assumes that the visitor is no longer interested in talking to the agent at this time. Therefore in step 154 his ID is removed from the queue and the system cycles to step 144. Optionally, an e-mail is automatically generated indicating that the visitor has missed his telephone call, and inviting him to visit and try the system at a future date.

As discussed above, in one embodiment, the system presents the agent with the ID and other information about the next visitor on the queue. Alternatively, the system can display information about several visitors at once, and the agent can decide which visitor he will handle next. He may make this determination based on his experience and the profile of the visitor, e.g., whether the visitor has browsed the website previously, or not, whether he is registered or not, etc. In one embodiment of the invention, visitors may register and several classes (e.g. silver, gold, platinum) of visitors may be established. The system can then generate several queues for the agents, one for gold members, one for silver, one for platinum, one for non-members, one for first time visitors, etc.

Using one or more of these criteria, the agent then selects the next visitor to be serviced. If the visitor is still available, then in step 156 his name is removed from the queue. In step 158 the agent is presented with the visitor's record (including his telephone number) together with an indication that this is a web-based call.

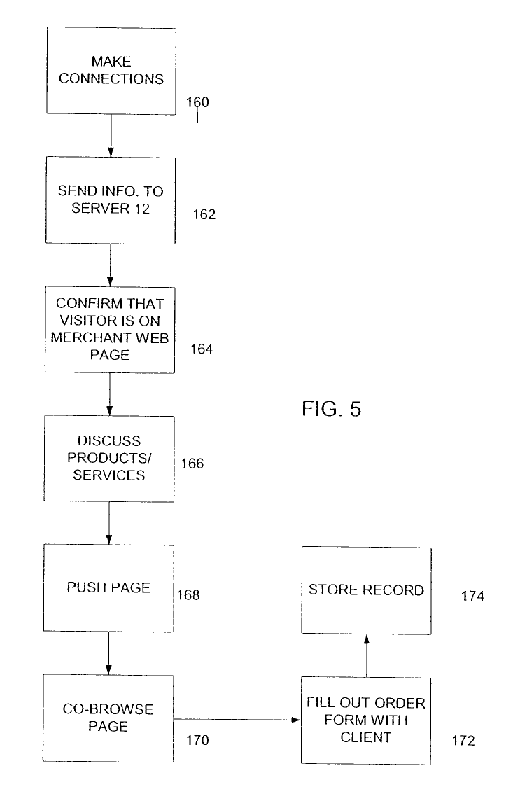

The agent is now ready to talk to the visitor, and the process for establishing actual communication between a visitor and an agent is now described in conjunction with the flow chart of FIG. 5. In step 160 server 12 establishes two voice links: one between the PSTN 18 and the call center 40, and another between the PSTN 18 and the telephone 32 of the visitor. Within the call center 40 the call is routed to the station 16. At the station, the agent is informed that the incoming call is web call by the client program running on PC 16. Integration between the client and the softphone is accomplished using either APIs or by using MS Windows events mechanisms. Using information from the server 12 and caller ID or other similar means the client on the PC 16 matches the caller to a visitor to the website 14. When the agent responds, the client sends a message to the server 12 indicating that a particular visitor on website 14 is the caller to this specific agent.

In case that the agent is using a telephone rather than a softphone, integration is achieved using CTI/Web integration. In this case the call center's computer telephony integration (CTI) is configured to send a web notification to the server 12 matching the phone number of the caller (using caller ID or other similar information) with the respective website visitor. As indicated above, in this process, the order in which the two calls are made are immaterial. In other words, the server 12 can request the connection to the client first, followed by a call to the call center 40, or vice versa.

In this manner a caller/visitor can be connected to an agent seamlessly. In an alternate embodiment, the server 12 can be used in an integrated mode by connecting the call center's telephone system using VOIP and bypassing the PSTN network entirely.

Once voice communication is established, the agent receives oral questions from the visitor, and provides oral responses directly. While this conversation is taking place, the agent's PC 18 and the visitor's PC are coupled so that while the agent and visitor talk to each other, the agent can confirm that the visitor is still on the web page (step 164) and can see the pages that the visitor has seen, as well as the page the visitor is viewing currently. The visitor and agent can discuss various issues related to certain services or products (step 166). In some situations, it is more convenient to present the visitor with information from the website rather then just giving him verbal information. Therefore, the agent can push pages from the website to the visitor as well (Step 168). The agent and visitor can also co-browse other pages of the website (Step 170).

Optionally, once all the visitor's questions are answered, the visitor can fill out a form on the website to complete a transaction, or the agent and visitor can cooperate to fill out the form (step 172).

Alternatively, the agent can get all the required information orally from the visitor and complete all or most of an order form himself.

Many of the functions associated with steps 162-172 are similar to the functions performed by a system when an agent chats on line with the visitor.

Once the conversation between the agent and visitor terminates (whether it results in a transaction or not), the visitor signs off. The agent then completes the visitor's record by entering any information he has received from the visitor in step 172 (unless he has already done so during the conversation with the visitor) including the call outcome such as sales amount and lead value. Next, in step 174 the record is stored until the next visit, and the agent is ready to assist the next visitor. All the information generated during the process is stored on the server 12 and is acted on by the system as required.

As mentioned above, preferably, the agent uses a VOIP-type telephone system for this exchange, while the visitor uses a separate telephone 32 connected to a standard POTS switching system 38. One of the advantages of this system is that the telephone number of the visitor appears on the record presented to the agent and the agent has only to point and select the number on his screen thereby having the system initiate the call. The call is then completed through the POTS 38 as shown.

However, the system may also be easily implemented by having the visitor use a VOIP system as well.

Alternatively, the agent could use a standard telephone or a cell phone 20A connected via standard telephone channels or a telephone switch. As previously mentioned, upon the visitor's request two calls are automatically generated by the server: one to the visitor and the other to an agent, not necessarily in this order. The two calls are then connected by the server. In this case, the agents' part of the call is actually connected to a third party call center 40, using the call center's existing infrastructure such as Interactive Voice Response (IVR) and Automatic Call Distribution (ACD) systems. The call that was originated by the server and terminated in the call center is then routed by the call center technology to an available and skilled agent. Once answered, the agent can talk to the visitor.

Even though the calls are terminated on a third party telephone switch or call center systems, the agent who is talking on the phone with a visitor can still engage a web collaboration session, view the same pages, see the visitor's web information, push web pages, perform co-browse and form filling, while talking on the phone.

The system has several advantages over the prior art. First, in a standard sales environment, a potential customer places a call to a customer service representative. Normally, the number is busy, or he is put on hold and has to wait for long time periods (periods of up to an hour are not unheard of). During this time, he has very little that he can do besides listening to music piped on the telephone, interrupted by commercials or inaccurate representations that he has to wait x minutes more for the next operator. In the present system, the visitor can continue browsing the web or even perform other tasks, since the agent is the one who will normally call him back.

Another advantage of the system is that once a visitor is registered and provides his telephone number, he is free to request telephone assistance with a click of a button and without the need of entering his telephone number or other information entered at the time the telephone assistance request was initiated.

As discussed above, during the telephone assistance session, the communication between the agent and visitor is very interactive, with the agent or may be the visitor pushing pages to each other, the two parties co-browsing or co-navigating the web page, joint form filling, highlighting of particular portions on a webpage, and so on.

The agent can be much more effective during the session described herein then during a standard telephone session, because at all times the agent has important information about the visitor, including the visitor's geographic location, navigation path, information about any referrer or search engine, etc.

The personal interaction between the agent and the visitor is very valuable for both parties. The visitor is dealing with a live human being instead of an automated voice messaging system. Moreover, the visitor may not want to call the agent for various reasons, including costs. By having the agent call the visitor, the visitor saves on the cost of a long distance call. This feature is especially important for international visitors. The visitor's whole experience during the session is enhanced by the seamless interface with the agent and the fact that the agent already has everything important literally at his fingertips, and thus respond to the visitor virtually instantaneously.

The agent benefits from the interaction with the visitor and gains insight on what the visitor is interested in at that particular moment, as well as generally, and use this information for co-selling other items during the same encounter or another future encounter.

Of course, the main reason for providing a system for telephone interaction between a visitor and an agent is to insure a user-friendly experience for the visitor during which any and all his questions are properly answered by a live person. This mode of operation then encourages the visitor to return to the website in the future even if he has not made a purchase during the current encounter. As mentioned above, the system captures information about each visitor, including the referrer (the webpage, email, or other document that sent the visitor to the present merchant's website). This information is incorporated into the record of the visitor and is also made available to the agent. The referrer information can be parsed to determine details on how the visitor arrived to the web site such as domain, page and, for a search engine, the relevant keywords, a relevant online campaign (banner, email) and so on. During or after an encounter with the visitor, the agent then uses at least some of this information and information obtained from the visitor to generate a report on the encounter. Information from the report is stored in the visitor's file and may be used for other purposes as well. For example this information (referrer information) combined with the call outcome information completed by the agent may be used to generate reports on the effectiveness of campaigns (banner, email and so on), effectiveness of search engines and keywords, and to calculate revenues payable to referrers, and so on. Any information about purchases, including items or services by the visitor, the values of these purchases, etc., are also recorded and compiled.

As described above while, a visitor is on a queue for a live agent, he is still to browse around the website. In alternate embodiment, voice communication is established between the visitor and the call center 40 as soon as it is requested by the visitor. However, if no agent is presently available, he receives a message that the agent is assisting other customers. He can listen to music piped from the system while is waiting. Preferably in this embodiment, visitors on hold receive priority and are handled first, before other visitors in the queue.

In summary, the system presented herein takes advantage of a client installed in the PC 16 which then manages the live agent feature and establishes the voice channel between a live agent and a visitor. This client is seamlessly integrated into the operation of the PC 16 and is used to establish the required voice channels using existing telephone switching mechanisms.

Numerous modifications may be made to the invention without departing from its scope as defined in the appended claims

We claim:

1. A method for providing information to a visitor of a website comprising:
generating a record including information about the visitor;
providing a selector on said website that when selected indicates that the visitor wants to establish telephone communication with a live agent;
establishing communication between said live agent and the visitor; and
performing a telephone conversation with the visitor.

2. The method of claim 1 further comprising providing a call center including a telephone interface and at least one workstation associated with a live agent, wherein said communication is established by said workstation.

3. The method of claim 1 further comprising performing co-browsing by said visitor and said agent.

4. The method of claim 1 further comprising filling a form jointly by said agent and said visitor, said form residing on said website.

5. The method of claim 1 wherein at least one of said agent and said client use a VOIP telephone for establishing said telephone communication channel.

6. The method of claim 1 further comprising generating a queue for a plurality of visitors requesting telephone communications, said queue determining the order in which said visitors are connected to said live agent.

7. The method of claim 1 further comprising generating a queue for a plurality of visitors requesting telephone communications, and automatically assigning one of several agents to each visitor.

8. The method of claim 7 wherein said agent is assigned by said telephone interface.

9. The method of claim 8 wherein agents are assigned to visitors based on predetermined criteria.

10. The method of claim 7 further comprising generating an expected response time for each visitor on the queue and presenting said times to said visitors.

11. The method of claim 10 wherein said expected to response time is provided to all visitors, independently of whether they have requested said telephone communication.

12. The method of claim 1 further comprising generating a record for each conversation.

13. The method of claim 12 wherein said record includes information identifying the referrer of the visitor.

14. The method of claim 13 wherein said information includes at least one of the referrer's site, the referrer's page, keywords used at the referrer's site to get to the present page, or the referrer's domain.

15. The method of claim 1 wherein a plurality of visitors are placed in a queue and wherein said agent selects the next visitor from said queue based on a predetermined criteria.

16. A system for providing information to a website visitor comprising:
a server connected to the Internet and providing a website accessible from the Internet to allow website visitors to review information and to request telephone communication with a live agent; and
a call center having an agent station operated by a live agent, said call center providing voice communication over a standard telephone system between a visitor and said agent in response to a request.

17. The system of claim 16 wherein the website is visited by a plurality of visitors requesting telephone communications and wherein said call center establishes a queue for said requests.

18. The system of claim 16 wherein said workstation includes a telephone.

19. The system of claim 18 wherein said telephone uses a VOIP protocol.

20. The system of claim 18 wherein said telephone is a standard telephone providing voice communications over telephone lines.
